(19) United States
(12) Patent Application Publication
(10) Pub. No.: US 2008/0134038 A1
(43) Pub. Date: Jun. 5, 2008

(54) INTERACTIVE INFORMATION PROVIDING SERVICE METHOD AND APPARATUS

(75) Inventors: Hyo Jung OH, Daejeon (KR); Chung Hee Lee, Daejeon (KR); Hyeon Jin Kim, Daejeon (KR); Chang Ki Lee, Daejeon (KR); Yi Gyu Hwang, Jeonju-si (KR); Ji Hyun Wang, Daejeon (KR); Myung Gil Jang, Daejeon (KR); Yun Keun Lee, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research, Daejeon (KR)

(21) Appl. No.: 11/951,154

(22) Filed: Dec. 5, 2007

(30) Foreign Application Priority Data
Dec. 5, 2006 (KR) 10-2006-122319
Jul. 25, 2007 (KR) 10-2007-74287
Nov. 21, 2007 (KR) 10-2007-119262

(51) Int. Cl. G06F 17/27; G10L 15/00

(52) U.S. Cl. 715/727; 704/9; 704/251; 704/E15.001

(57) ABSTRACT

Provided are a method and apparatus for providing information according to a user's request, and more particularly, an interactive information providing service method and apparatus for analyzing a user's request and providing information corresponding to the request on the basis of a dialog input received from the user. The apparatus includes: a conversation sentence analyzer for analyzing an input sentence received from a user; a conversation manager for analyzing the user's request using an analysis result of the conversation sentence analyzer; a real-time automatic knowledge builder for extracting in real time daily information updated on the web and storing the information in a daily information database when there is a real-time information update request from the conversation manager; a response generator for generating a response to the user's request analyzed by the conversation manager and providing the response to the user; and an exception handler for allowing the user to cancel his/her request and restoring the system when it is not possible to respond to the user's request, or when there is an error in the response to the user's request. On the basis of dialog input, the method and apparatus analyze a user's request and provide information corresponding to the request, thereby enabling the user to easily obtain needed information.

### CROSS-REFERENCE TO RELATED APPLICATION

This application claims priority to and the benefit of Korean Patent Application No. 2006-122319, filed Dec. 5, 2006, No. 2007-74287, filed Jul. 25, 2007, and No. 2007-119262, filed Nov. 21, 2007, the disclosure of which is incorporated herein by reference in its entirety.

### BACKGROUND

1. Field of the Invention

The present invention relates to a method and apparatus for providing information according to a user's request, and more particularly, to an interactive information providing service method and apparatus for analyzing a user's request and providing information corresponding to the request on the basis of a dialog input received from the user.

This work was supported by the IT R&D program of MIC/IITA. [2006-S-036-01, Development of large vocabulary/interactive distributed VUI for new growth engine industries].

2. Discussion of Related Art

With development of technology, information providing systems for efficiently providing needed information to users have been researched and developed by many developers.

In general, conventional information providing service apparatuses provide users with an inconvenient interface such as a multi-step search that supports an input based on a keyword search method or a menu-driven method and retrieves again needed information from the searched result. Thus, the conventional information providing service apparatuses cause inconvenience to users.

In addition, conventional information providing service apparatuses using dialog input support limited functions only, such as simple application control.

### SUMMARY OF THE INVENTION

The present invention is directed to an interactive information providing service apparatus and method enabling a user to more conveniently obtain desired information through dialog input.

One aspect of the present invention provides an interactive information providing service method, comprising the steps of: analyzing an input sentence received from a user; analyzing the user's request on the basis of the analyzed input sentence; extracting daily information in real time and storing the daily information in a daily information database; extracting information corresponding to the analyzed user's request from the daily information database; and outputting the extracted information to the user.

Another aspect of the present invention provides an interactive information providing service apparatus, comprising: a conversation sentence analyzer for analyzing an input sentence received from a user; a conversation manager for analyzing the user's request using an analysis result of the conversation sentence analyzer; a real-time automatic knowledge builder for extracting in real time daily information updated on the web and storing the information in a daily information database when there is a real-time information update request from the conversation manager; a response generator for generating a response to the user's request analyzed by the conversation manager and providing the response to the user; and an exception handler for allowing the user to cancel his/her request and restoring the system when it is not possible to respond to the user's request, or when there is an error in the response to the user's request.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of an interactive information providing service apparatus according to an exemplary embodiment of the present invention;

FIG. 2 is a block diagram showing detailed constitutions of a conversation sentence analyzer, a conversation manager and a response generator shown in FIG. 1;

FIG. 3 is a block diagram showing a detailed constitution of a real-time automatic knowledge builder shown in FIG. 1; and

FIG. 4 is a block diagram showing a detailed constitution of an exception handler shown in FIG. 1.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

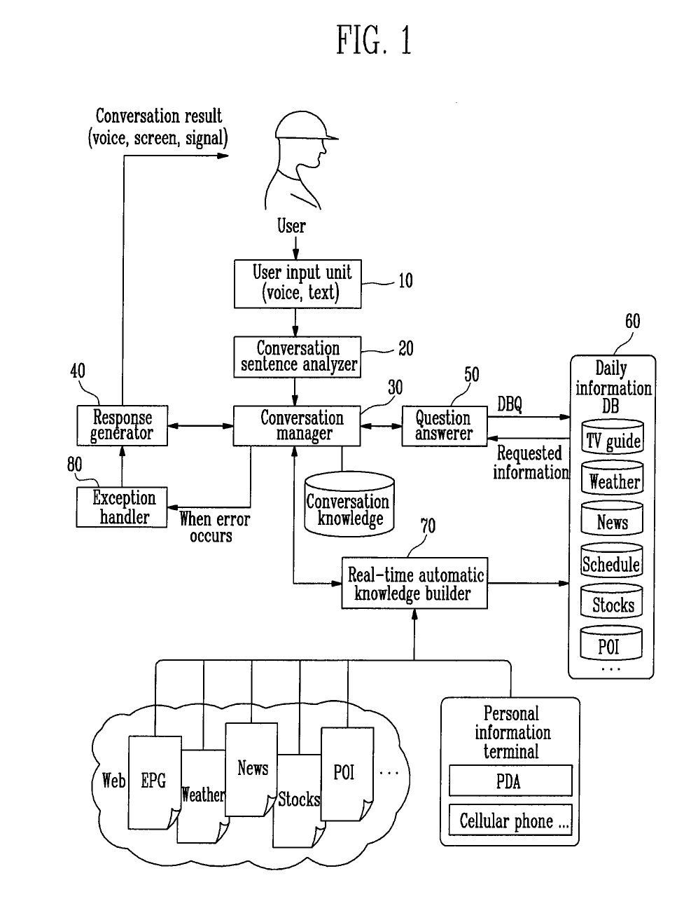

FIG. 1 is a block diagram of an interactive information providing service apparatus according to an exemplary embodiment of the present invention.

The interactive information providing service apparatus according to an exemplary embodiment of the present invention may be included in a terminal, such as a personal computer, a mobile device, e.g., a cellular phone and Personal Digital Assistant (PDA), and a home appliance, e.g., a digital television (TV), and perform an interactive information providing service for a user.

Referring to FIG. 1, the interactive information providing service apparatus includes a user input unit 10, a conversation sentence analyzer 20, a conversation manager 30, a response generator 40, a question answerer 50, a real-time automatic knowledge builder 70, and an exception handler 80.

The user input unit 10 receives an input signal having the form of a voice signal or a text string signal from a user, and transfers the signal to the conversation sentence analyzer 20. The conversation sentence analyzer 20 performs language analysis of the input signal and transfers the analysis result to the conversation manager 30. The conversation manager 30 recognizes the user's request using the analysis result of the conversation sentence analyzer 20 and then requests the question answerer 50 for information. The question answerer 50 searches a daily information database 60, retrieves the information requested by the user, and transfers the information to the conversation manager 30. The conversation manager 30 provides the information to the user through the response generator 40.

When it is not possible to respond to an input sentence input by the user, the exception handler 80 verifies the input sentence by requesting the user to check the input sentence. When an error occurs during the operation of the system, the exception handler 80 allows the user to cancel the operation or an order and restores the system.

When a real-time information update request is received from the conversation manager 30, the real-time automatic knowledge builder 70 extracts in real time daily information updated on the web and transfers the updated information to the conversation manager 30 and the conversation sentence analyzer 20. The daily information may include information on Electronic Program Guide (EPG), weather, news, stocks, and Point of Interest (POI).

The updated information is stored in the daily information database 60 according to respective fields, such as TV guide, weather, news, personal schedule, stocks, and POI, and is used for the question answerer 50 to retrieve information. Here, the POI is a location-based service providing information on a region that a user is interested in.

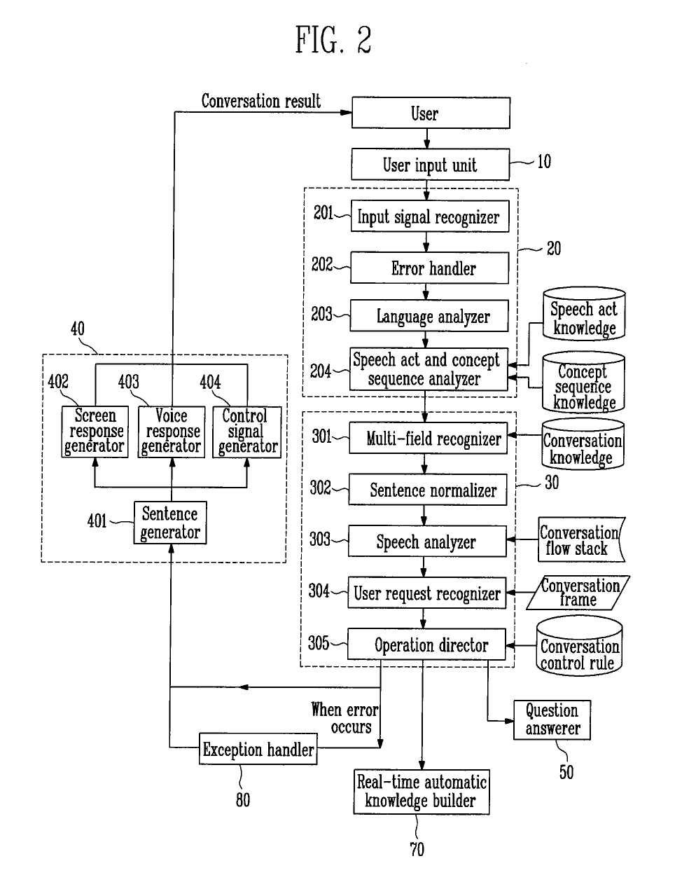

FIG. 2 is a block diagram showing detailed constitutions of the conversation sentence analyzer 20, the conversation manager 30 and the response generator 40 shown in FIG. 1.

Operation of the conversation sentence analyzer 20 will be described in detail with reference to FIG. 2. First, an input signal recognizer 201 recognizes a voice signal, a text signal, etc., that a user inputs. Here, an input sentence that the user inputs includes natural (continuous) speech and isolated speech. Examples of input continuous speech and isolated speech are given below.
Input sentence of natural (continuous) speech: What dramas are on SBS tomorrow? Search for a program with Jaeseok Yu.
Input sentence of isolated speech: Tomorrow SBS Drama Search. Jaeseok Yu Program Search.

When there is an error in the input sentence, e.g., a chatting-like speech manner, an emoticon, a typographical error, an expletive, a contraction and an error in spacing words, an error handler 202 corrects the error and generates a corrected input sentence. When the error handler 202 fails in error correction, the user is informed of the error and induced to input a voice signal or a text signal again. A language analyzer 203 performs language analysis, such as morphological analysis, named entity recognition, syntactic analysis, etc., of the input sentence. A speech act and concept sequence analyzer 204 analyzes a speech act and a concept sequence of the linguistically analyzed input sentence, which are information that the user wants, on the basis of a database having previously stored speech act and concept sequence knowledge. The analysis result of the input sentence is transferred to the conversation manager 30. Examples of a speech act and a concept sequence of an input sentence analyzed on the basis of previously stored speech act and concept sequence knowledge data are given below.
User's input sentence: What's the weather like in Daejeon today?
Analysis result of concept sequence: What's the weather like <in Daejeon: location> <today: date>?
Analysis result of speech act: search_weather

Operation of the conversation manager 30 will be described in detail with reference to FIG. 2. Using the analyzed speech act and concept sequence information, a multi-field recognizer 301 analyzes which field the user wants the daily information from. A sentence normalizer 302 normalizes the input sentence. A speech analyzer 303 performs speech analysis with reference to already-stored former conversation flow data. While multi-field recognition and sentence normalization are performed for the current input sentence, speech analysis is performed on the basis of an already-stored previous conversation to supplement referred information, such as a substitute word, an omitted word, and so on.

A user request recognizer 304 recognizes the user's request using the speech act, the concept sequence, the field information, the substitute word, and the omitted words obtained by speech act and concept sequence analysis and speech analysis. The user's request is analyzed in the form of a frame and is transferred to an operation director 305. An example of a final speech analysis result transferred to the operation director 305 is given below.
Previous question of a user: Chinese restaurant near Choongnam University.

| Frame slot | Value |
|---|---|
| POI | ? |
| Category | Chinese restaurant |
| From | Choongnam University(10,1,17:15,122,8) |
| Distance | In the neighborhood |

Previous answer of a system: “Yun-rea-choon”
Current question of the user: How long does it take?
Concept sequence analysis result: How long does it take?
Speech act analysis result: search_distance
Field recognition: POI field
Speech analysis: How long does it take <from here to a restaurant near Choongnam university: omitted word>?
Sentence normalization: here→GPS coordinates=(10,1,15.2:15,124,20)
Recognition of the user's intention:

| Frame slot | Value |
|---|---|
| POI | Yun-rae-choon |
| Category | Chinese restaurant |
| From | Here(10,1,15.2:15,124,20) |
| Distance | ? |

Current answer of the system: It is 2 kilometers from here to Yun-rae-choon.

When the user wants to obtain information, the operation director 305 calls the question answerer 50 and retrieves the corresponding information using the final analysis result of the input sentence. When it is verified whether the user's request is available, or an error has occurred in the system, the operation director 305 calls the exception handler 80. In addition, the operation director 305 transfers a final result obtained by performing the operation that the user wants to the user through the response generator 40, and performs feedback to the real-time automatic knowledge builder 70 to update daily information in real time.

Operation of the response generator 40 will be described in detail with reference to FIG. 2. When the user makes a conversation to obtain a single piece of information, a sentence generator 401 generates a natural sounding reply sentence, and a voice response generator 403 provides the reply sentence to the user using synthesized sound. When the user makes a conversation to obtain a plurality of pieces of information or to see an output, such as news, etc., a screen response generator 402 displays image information on a screen of a terminal.

In addition, when the user makes a conversation to control the terminal to guide the user to a destination, simulate driving, etc., a control signal generator 404 may transfer a terminal control signal. For example, the response generator 40 may answer through the screen response generator 402, the voice response generator 403 or the control signal generator 404 according to a conversation sentence input by a user, as given below.

Example 1)—User input: What channel is the baseball on today?
Answer: ‘The Korean Series: Game 3’ will be on KBS2 at 6 o'clock this evening.

Example 2)—User input: Show me today's Business News.
Answer: This is the Business News for Oct. 23, 2006. It's on the screen.

Example 3)—User input: Let's go to 63 building.
Answer: (start navigation guide)

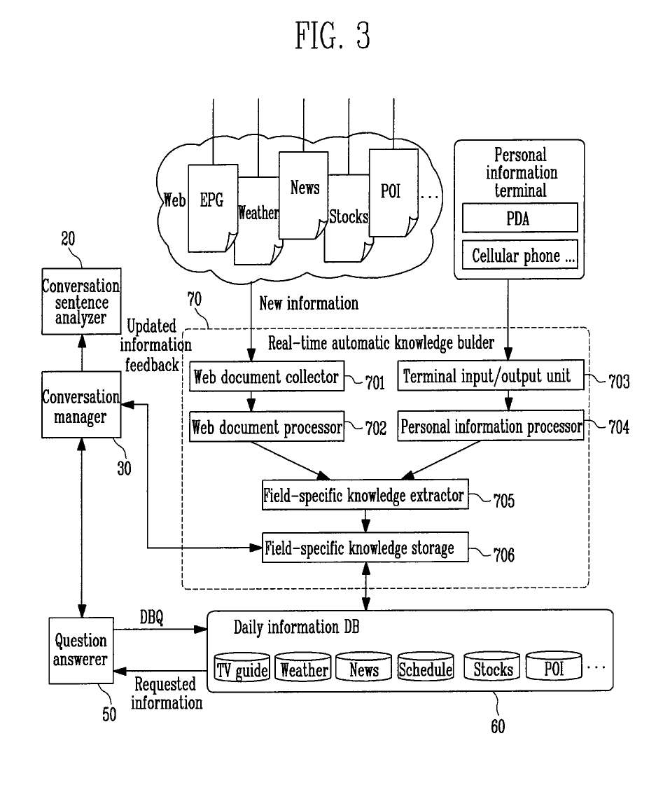

FIG. 3 is a block diagram showing a detailed constitution of the real-time automatic knowledge builder 70 shown in FIG. 1. When a real-time information update request is received from the conversation manager 30, the real-time automatic knowledge builder 70 obtains, in real time, daily information of multiple fields updated on the web and performs processing, storing and expanding of the information.

Operation of the real-time automatic knowledge builder 70 will be described in detail with reference to FIG. 3. A web document collector 701 collects in real time a web document including new information that is updated every day, and a web document processor 702 parses and analyzes the collected web document and retrieves needed daily information. Personal schedule information stored in a personal information terminal, such as a Personal Digital Assistant (PDA) or a cellular phone, or embedded information, such as a map, needed to be periodically updated is collected through a terminal input/output unit 703 and a personal information processor 704.

The daily information collected from the web document or the personal terminal is extracted by a field-specific knowledge extractor 705, and structured and stored by a field-specific knowledge storage 706. The information is stored in the daily information database 60 according to respective fields, such as TV guide, weather, news, personal schedule, stocks, POI, etc., and is used for the question answerer 50 to retrieve information.

Updated information is fed back by the conversation manager 30 to the input signal recognizer 201 of the conversation sentence analyzer 20, and thereby is known to the entire system.

The daily information database 60 has an expandable structure, and thus can cope with a request for the addition and expansion of new field services other than existing fields.

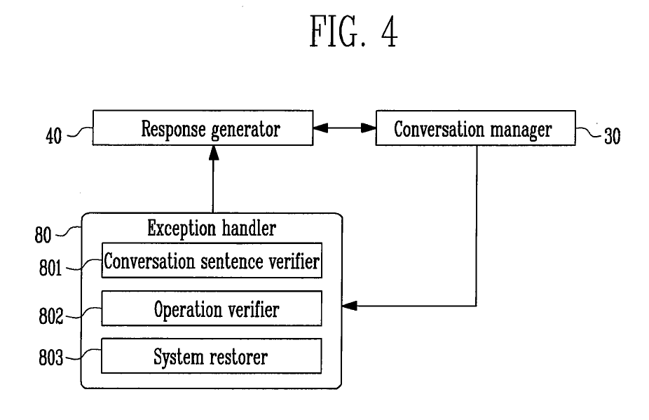

FIG. 4 is a block diagram showing a detailed constitution of the exception handler 80 shown in FIG. 1. The exception handler 80 serves to restore and verify the system when the user gives an order that cannot be responded to or performed, or the system malfunctions.

Operation of the exception handler 80 will be described in detail with reference to FIG. 4. A conversation sentence verifier 801 verifies whether the user has input a question that can be answered using a conversation frame analyzed by the conversation manager 30, and an operation verifier 802 verifies whether an order to perform the final mission that the user requests can be carried out. When the user makes a speech that cannot be responded to or performed, the system makes the user check whether his/her input sentence is correct to verify the sentence.

When the apparatus malfunctions, a system restorer 803 allows the user to cancel the user's request and restores the system. Then, the system is restored by the system restorer 803 to a state in which the user has not yet made the current speech. Examples of verification of an operation requested by the user and system restoration are given below.

Example 1)—User input 1: Closing prices of stocks of “Samsung eletro”.
Answer 1: There is no “Samsung eletro”. If you want “Samsung electronics,” please enter number 1. If you want “Samsung electro-mechanics,” please enter number 2.

Example 2)—User input 1: Guide me to 63 building.
Answer 1: Starting a guide to 63 building on Yeouido.
User input 2: Stop. Cancel it.
Answer 2: Cancelled. Where do you want me to guide you?

Meanwhile, the above-described exemplary embodiments can be written as a program that can be executed by computers, and can be implemented in general-purpose computers executing the program using a computer-readable recording medium. The computer-readable recording medium may be a magnetic storage medium, e.g., a read-only memory (ROM), a floppy disk, a hard disk, etc., an optical reading medium, e.g., a compact disk read-only memory (CD-ROM), a digital versatile disc (DVD), etc., and carrier waves, e.g., transmission over the Internet.

As described above, the present invention analyzes a user's request and provides information corresponding to the request on the basis of dialog input, thereby enabling the user to conveniently obtain needed information.

In addition, the present invention collects in real time a variety of new information updated every day on the web and thereby can rapidly provide a user with new information.

Furthermore, according to the present invention, a control signal is transmitted to a terminal including an interactive information providing service apparatus while information is provided based on dialog input. Thus, a user can conveniently control the terminal to perform an operation needed according to retrieved information.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An interactive information providing service method, comprising the steps of:
analyzing an input sentence received from a user;
analyzing a user's request on the basis of the analyzed input sentence;
extracting daily information in real time, and storing the daily information in a daily information database;
extracting information corresponding to the analyzed user's request from the daily information database; and
outputting the extracted information to the user.

2. The interactive information providing service method of claim 1, wherein the input sentence received from the user is input by recognizing the user's voice or inputting a string of characters.

3. The interactive information providing service method of claim 1, wherein the daily information database receives in real time daily information updated on the web or personal schedule information updated in a personal information terminal, and stores the information in each information field.

4. The interactive information providing service method of claim 3, wherein the information fields comprise a TV guide, news, weather, a personal schedule, stocks, and a location-based service.

5. The interactive information providing service method of claim 1, wherein the step of analyzing an input sentence received from a user comprises the steps of:
when there is an error in the received input sentence, correcting the input sentence;
performing language analysis by morphological analysis, named entity recognition and syntactic analysis of the input sentence; and
extracting a speech act and a concept sequence from the linguistically analyzed input sentence on the basis of a database having previously stored speech act and concept sequence knowledge.

6. The interactive information providing service method of claim 5, wherein the step of analyzing the user's request comprises the steps of:
analyzing a field of information that the user wants on the basis of the analyzed input sentence, and normalizing the input sentence;
analyzing an omitted word and a substitute word in the input sentence with reference to already-stored previous conversation data;
analyzing the user's request using the speech act, the concept sequence, the information field, the substitute word, and the omitted word; and
selecting an operation corresponding to the analyzed user's request.

7. The interactive information providing service method of claim 6, wherein the step of analyzing the user's request further comprises the steps of:
when it is not possible to respond to the user's request, making the user verify his/her request; and
when there is an error in a response to the user's request, allowing the user to cancel his/her request.

8. The interactive information providing service method of claim 7, wherein the step of outputting the extracted information to the user is performed by providing speech, providing image information or transferring a terminal control signal.

9. A computer-readable recording medium storing a program for executing the method of claims 1 in a computer system.

10. An interactive information providing service apparatus, the apparatus comprising:
a conversation sentence analyzer for analyzing an input sentence received from a user;
a conversation manager for analyzing a user's request using an analysis result of the conversation sentence analyzer;
a real-time automatic knowledge builder for extracting in real time daily information updated on the web, and storing the information in a daily information database when there is a real-time information update request from the conversation manager;
a response generator for generating a response to the user's request analyzed by the conversation manager, and providing the response to the user; and
an exception handler for allowing the user to cancel his/her request and restoring the system when it is not possible to respond to the user's request or when there is an error in the response to the user's request.

11. The interactive information providing service apparatus of claim 10, wherein the conversation sentence analyzer comprises:
an input signal recognizer for recognizing the input sentence received from the user;
an error handler for correcting the input sentence when there is an error in the input sentence;
a language analyzer for performing morphological analysis, named entity recognition and syntactic analysis of the input sentence; and
a speech act and concept sequence analyzer for analyzing a speech act and a concept sentence of the input sentence.

12. The interactive information providing service apparatus of claim 11, wherein the conversation manager comprises:
a multi-field recognizer for recognizing a field of information that the user wants using the speech act and the concept sentence of the input sentence;
a sentence normalizer for normalizing the input sentence;
a speech analyzer for analyzing a substitute word and an omitted word in the input sentence with reference to already-stored conversation data;
a user request recognizer for analyzing the user's request using the speech act, the concept sequence, the information field, the substitute word, and the omitted word; and
an operation director for directing an operation according to the analyzed user's request.

13. The interactive information providing service apparatus of claim 12, wherein the response generator comprises:
a voice response generator for providing a voice response when it is determined that the user's request is for obtaining a single piece of information;
a screen response generator for providing an image response on a screen of a terminal when it is determined that the user's request is for obtaining a plurality of pieces of information or obtaining image information; and
a control signal generator for transferring a terminal control signal when it is determined that the user's request is for controlling the terminal.

14. The interactive information providing service apparatus of claim 13, wherein the exception handler comprises:
a conversation sentence verifier for verifying whether the user inputs an answerable question;
an operation verifier for determining whether the operation requested by the user can be performed, and when the user's request cannot be performed, making the user verify his/her request; and
a system restorer for allowing the user to cancel his/her request and restoring the system when there is an error in the response to the user's request.

15. The interactive information providing service apparatus of claim 14, wherein the real-time automatic knowledge builder comprises:
a web document collector for collecting a web document in real time;
a web document processor for parsing and analyzing the web document collected in the web document collector and extracting daily information;
a terminal input/output unit for receiving information stored in a personal information terminal;
a personal information processor for analyzing the information inputted via the terminal input/output unit and extracting effective information;
a field-specific knowledge extractor for extracting daily information from the information processed by the web document processor and the personal information processor; and
a field-specific knowledge storage for structuring and storing the information extracted by the field-specific knowledge extractor.
